(19) United States
(12) Patent Application Publication
(10) Pub. No.: US 2026/0017578 A1
(43) Pub. Date: Jan. 15, 2026

(54) AUTONOMOUS GENERATION OF TASK COMPLETION NARRATIVES

(71) Applicant: Oracle International Corporation, Redwood Shores, CA (US)

(72) Inventors: Saurabh Shrivastava, Fremont, CA (US); Nicholas Vautier, San Carlos, CA (US)

(73) Assignee: Oracle International Corporation, Redwood Shores, CA (US)

(21) Appl. No.: 18/767,304

(22) Filed: Jul. 9, 2024

(51) Int. Cl. G06Q 10/0631; G06F 40/186

(52) U.S. Cl. CPC G06Q 10/063114; G06F 40/186

(57) ABSTRACT

A task management system detects condition(s) are satisfied with respect to task record(s), and triggers action(s) at least in part by substituting information from the task record(s) into placeholder(s) of user-modifiable template(s) to prompt large language model(s) for generating narrative(s) about how the condition(s) were satisfied. The triggered action(s) retrieve information from identified task record(s), substitute value(s) from the record(s) into the placeholder(s) of the user-modifiable template(s), and trigger(s) call(s) to large language model(s) to generate task completion narrative(s) or other narrative(s) for the task record(s). The narrative(s) may be stored in narrative field(s) of the record(s) for use in displaying the narrative(s) on a user interface, email notification, or other message.

### BACKGROUND

Database systems are used to store information about projects, opportunities, experiments, software design phases, product development, training procedures, and other tasks that are being managed by software applications. The software applications may store such information in database tables or other database structures, such that details about the tasks are available for analysis using tools native to the software applications.

Software applications built for different purposes may provide different types of analysis and offer different functionality with respect to the task data being managed. If the task data is sparse or incomplete, any analysis of such data by the software applications may be less reliable, more error prone, and of limited applicability. As a result, maximizing value from such software applications may be dependent on high-quality data based on frequent and time-consuming updates by users responsible for the high-quality data.

However, even if a user provides up-to-date task data at any given time, a status of the task may change without warning to the user, and at a time where the user is not available to provide further updates. A reason for the status change may be unclear or require significant analysis based on the data that has been provided, and tasks that have been completed might never be revisited by the relevant user to provide more precise updates on why the status changed to completed. Even if the task is abandoned or rejected, such task might never be revisited to provide more precise updates on why the task was abandoned or rejected.

Often, time is not allocated to completed, abandoned, rejected, or other finally disposed tasks, as organizations are often forward-looking towards tasks that may be helpful to grow the business. As a result, organizations may continue to make the same mistakes over and over again without the benefit of understanding the undocumented why and how those mistakes are being made. Similarly, organizations might be slow to adapt to and uptake strategies that are successful even when mistakes are not being made.

Currently, the value of task management applications is highly dependent on the hard work of organization personnel to input high-quality data in a time intensive manner that extends beyond the lifecycle of when the organization originally benefitted from the task completion.

### BRIEF SUMMARY

In some embodiments, a computer-implemented method is performed by a task management system that detects condition(s) are satisfied with respect to task record(s), and triggers action(s) at least in part by substituting information from the task record(s) into placeholder(s) of user-modifiable template(s) to prompt large language model(s) for generating narrative(s) about how the condition(s) were satisfied. The triggered action(s) retrieve information from identified task record(s), substitute value(s) from the record(s) into the placeholder(s) of the user-modifiable template(s), and triggers call(s) to large language model(s) to generate task completion narrative(s) or other narrative(s) for the task record(s). The narrative(s) may be stored in narrative field(s) of the record(s) for use in displaying the narrative(s) on a user interface, email notification, or other message.

In one embodiment, a computer-implemented method includes storing a plurality of task records. Each task record includes characteristics of a task of a plurality of tasks and a task status. A particular task record for a particular task includes a particular task status value for the task status that indicates the particular task is not completed. The particular task record identifies, in association with the task, a team of one or more actors of a plurality of actors and a candidate partner of a plurality of candidate partners. The computer-implemented method further includes storing an action trigger in association with the plurality of task records. The action trigger includes one or more conditions that are based at least in part on the task status, and a referenced API that uses a specified path to call a large language model. The computer-implemented method further includes storing a user-modifiable template for prompts to the large language model, the user-modifiable template including a plurality of placeholders for a plurality of characteristics including one or more particular characteristics, the user-modifiable template further including modifiable static text to appear in the prompts. For the particular task record, an update to the particular task status value is received, the update indicating the particular task is completed. The one or more particular characteristics of the particular task record include one or more particular values that are unique to the particular task among the plurality of tasks. Based at least in part on the update, the computer-implemented method includes detecting that the one or more conditions are satisfied for the particular task record. In response to detecting that the one or more conditions are satisfied for the particular task record, the computer-implemented method includes generating a task completion narrative at least in part by identifying the particular task record for the task completion narrative, populating the user-modifiable template to generate a particular prompt at least in part by substituting the one or more particular values of the one or more particular characteristics for one or more placeholders of the plurality of placeholders, and triggering a call to the large language model using the specified path. The call includes the particular prompt to the large language model including the one or more particular values of the one or more particular characteristics of the particular task record and the modifiable static text. The computer-implemented method further includes receiving and storing the task completion narrative in a task completion narrative field of the particular task record, and accessing the task completion narrative field to cause display of the task completion narrative to at least one actor of the plurality of actors.

In a further embodiment, the one or more particular characteristics of the particular task record comprise one or more other particular values that are shared by one or more other tasks of the plurality of tasks. The computer-implemented method further includes receiving, via a user interface, a request for information relating to tasks having the one or more other particular values. Accessing the task completion narrative field to cause display of the task completion narrative is performed in response to the request.

In the same or a different further embodiment, the one or more particular values describe one or more interactions between the team and the candidate partner in natural language text. The modifiable static text comprises one or more section headers of one or more blank sections to be completed by the large language model. The computer-implemented method further includes generating, by the large language model, one or more summaries of the one or more interactions to address the one or more section headers, and including the one or more summaries in the task completion narrative to fill in the one or more blank sections.

In the same or a different further embodiment, the computer-implemented method further includes accessing one or more values of one or more characteristics of the plurality of characteristics. The computer-implemented method further includes determining that the one or more values of the one or more characteristics of the plurality of characteristics satisfy one or more data exclusion conditions. Based at least in part on determining that the one or more values of the one or more characteristics satisfy the one or more data exclusion conditions, the computer-implemented method includes excluding the one or more values from the particular prompt even though the user-modifiable template comprises one or more placeholders for the one or more characteristics.

In the same or a different further embodiment, generating the task completion narrative further includes receiving an initial task completion narrative from the large language model, and determining whether the initial task completion narrative comprises any data characteristics that satisfy one or more data exclusion conditions. Based at least in part on determining the initial task completion narrative comprises one or more data characteristics that satisfy the one or more data exclusion conditions, the computer-implemented method includes prompting the large language model to provide another task completion narrative that removes the one or more data characteristics from the initial task completion narrative.

In the same or a different further embodiment, the computer-implemented method further includes storing one or more validation rules in association with the task completion narrative field. The one or more validation rules comprise one or more constraints on content that can be stored in the task completion narrative field. Storing the task completion narrative in the task completion narrative field is performed based at least in part on determining that the one or more constraints are satisfied.

In the same or a different further embodiment, accessing the task completion narrative field to cause display of the task completion narrative to at least one actor comprises triggering an email communication to at least one other team of a plurality of teams. The particular task record is not modifiable by at least one actor of the plurality of actors on the at least one other team.

In the same or a different further embodiment, accessing the task completion narrative field to cause display of the task completion narrative to at least one actor comprises triggering an email communication to at least one actor on the team. The email communication comprises an interactive option which, when selected, triggers one or more email communications to at least one other team of a plurality of teams. The particular task record is modifiable by the at least one actor on the team but is not modifiable by at least one other actor of the plurality of actors on the at least one other team.

In the same or a different further embodiment, the particular prompt includes an example of another task completion narrative that is based on other information that does not have the one or more particular values for the one or more particular characteristics but has one or more other values for the one or more particular characteristics.

In the same or a different further embodiment, the one or more particular characteristics of the particular task record comprise one or more other particular values that are shared by one or more other tasks of the plurality of tasks. The computer-implemented method further includes summarizing a plurality of task completion narrative fields for a plurality of tasks sharing a particular value of the one or more other particular values at least in part by prompting the large language model with the plurality of task completion narrative fields and other modifiable static text.

In the same or a different further embodiment, the computer-implemented method includes detecting that at least one of the plurality of characteristics is in a different language than a target language of the particular prompt, and transforming the at least one of the plurality of characteristics to the target language before including the at least one of the plurality of characteristics in the particular prompt.

In the same or a different further embodiment, the computer-implemented method further includes detecting that at least one of the plurality of characteristics may be in a different language than a target language of the particular prompt, and adding, to the particular prompt, text requesting that the task completion narrative be provided in the target language.

In the same or a different further embodiment, accessing the task completion narrative field to cause display of the task completion narrative to at least one actor comprises conditionally rendering the task completion narrative field in a user interface for viewing details about the particular task based at least in part on determining that the task completion narrative field is not blank.

In the same or a different further embodiment, the computer-implemented method includes causing display of the user-modifiable template at least in part by displaying the plurality of placeholders as movable graphical objects within the modifiable static text.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process that detects condition(s) are satisfied with respect to task record(s), and triggers action(s) including substituting information from the task record(s) into placeholder(s) of user-modifiable template(s) to prompt LLM(s) for generating narrative(s) about how the condition(s) were satisfied.

FIG. 2 illustrates a system diagram showing an example system that detects condition(s) are satisfied with respect to task record(s), and triggers action(s) including substituting information from the task record(s) into placeholder(s) of user-modifiable template(s) to prompt LLM(s) for generating narrative(s) about why the condition(s) were satisfied.

FIG. 3 illustrates a diagram of an example user interface showing a generated narrative about why condition(s) were satisfied for an existing task that is similar to a target task.

FIG. 4 illustrates a diagram of an example user interface showing a user-modifiable prompt template to prompt LLM(s) for generating narrative(s) about why condition(s) are satisfied.

FIG. 5 depicts a simplified diagram of a distributed system for implementing certain aspects.

FIG. 6 is a simplified block diagram of one or more components of a system environment by which services provided by one or more components of an embodiment system may be offered as cloud services, in accordance with certain aspects.

FIG. 7 illustrates an example computer system that may be used to implement certain aspects.

### DETAILED DESCRIPTION

A task management system detects condition(s) are satisfied with respect to task record(s), and triggers action(s) at least in part by substituting information from the task record(s) into placeholder(s) of user-modifiable template(s) to prompt large language model(s) for generating narrative(s) about how the condition(s) were satisfied. The narrative(s) may be stored in narrative field(s) of the record(s) for use in displaying the narrative(s) on a user interface, email notification, or other message. In various embodiments, the task management system is implemented using non-transitory computer-readable storage media to store instructions which, when executed by one or more processors of a computer system, cause display of the user interface and processing of received input to manage tasks. The task management system may be implemented on a local or cloud-based computer system that includes processors and a display for showing the user interface to a user for managing tasks. The computer system may communicate with client computer systems for managing tasks.

A description of the task management system is provided in the following sections:
MANAGING RECORDS AND RECORD NARRATIVES
CUSTOM FIELDS, STATUSES, AND ACTION TRIGGERS
LARGE LANGUAGE MODELS PROVIDING NARRATIVES
PROMPT TEMPLATES
INTELLIGENTLY PERSISTED TASK NARRATIVES
POST-PROCESSING TRANSFORMATION OF NARRATIVES
DOWNSTREAM CONTENT AUTOMATICALLY INCORPORATING NARRATIVES
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### Managing Records and Record Narratives

Database systems include database structures that store database records. Each database record includes data fields for which values may be assigned. The database records may include static fields for which values are provided for the record as well as dynamic fields (e.g., virtual fields or formula fields) that are deterministically based on or otherwise dependent on other fields. The static fields may be updated by user(s) or application(s) and stored in the database until further update. Values of the dynamic fields may update as the field values from which they depend are updated. For example, the formula fields have values that may change each time they are accessed if the values from which they depend have also changed.

Database records may be used to track task completion, where each record reflects a task for which the corresponding fields represent characteristics of the task or sub-tasks involved in the task. The task may be associated with any of:
a task coordinator, task performer, or other task actor,
a partner who benefits from, pursues, or contributes to the performance of the task,
a competitor who is an alternative candidate task performer or other task actor,
individual characteristic(s), such as locations, job roles, positions, budgets, entity/company sizes, entity/company revenue, employees, categories, industries, etc. of any of the entities above,
a task size, budget, predicted resource consumption, and/or predicted resource allocation,
a target completion date or timeline, and/or
any other characteristic associated with the task, completion, partial completion, or non-completion of the task, or completion, partial completion, or non-completion of any sub-task;

As a task progresses towards completion, static fields of the record corresponding to the task may be updated to reflect the progress. Dynamic fields may update based on the values of updated static fields or other dynamic fields. Characteristics may be updated to indicate circumstances or intermediate outcomes that are occurring as the task progresses.

Some circumstances or intermediate outcomes may be similar to or the same as circumstances or intermediate outcomes that occurred for other tasks. Some circumstances or intermediate outcomes may be unique to a given task, with little or no overlap in the circumstance for other tasks. For example, a sub-task may be to schedule an introductory call to discuss a partnership opportunity, and this sub-task may occur with different dates, different durations, and/or different participants but otherwise occur similarly across different tasks that involve partnering with an entity before the task can be completed. Specific meetings, such as the initial pitch or a first follow-up call may even have their own custom fields on the task record. As used herein, a “partner” for a task includes an established partner based on a completed task for which cooperation, coordination, or other partnership between an actor and the partner was involved, or a candidate partner based on a non-completed task for which partnership was sought by the partner or another actor but has not yet occurred. As another example, a sub-task of a particular task may be to evaluate whether parameters of the particular task are compatible with local regulations that are specific to a particular partner, and the particular partner may be unique to the particular task.

Some values of the records may be updated by user participants who are involved in performing or documenting the task progress. As a task progresses, a user participant may update characteristic(s) of the task that have changed since the task was initiated, may update expected date(s) for intermediate benchmark(s), and/or may update expected date(s) for task completion. Some updated value(s) may provide a description of sub-tasks and characteristics that have led to a certain point on a path towards task completion. Some updated value(s) may reflect the current status of the task and a reason for the current status, and this current status and the reason may change over time as the record is updated.

The database system may track historical changes to the record based on timestamps associated with the changes, and/or individual users may recall how a record has changed and provide written summaries or descriptions about the task, the task status, and/or the changes made. As used herein, a “narrative” is a written description that is based on and incorporates aspects of the task that are unique to the task or shared by other tasks, such as aspects that may have changed throughout the lifetime of the task(s) and/or aspects that describe entities, objects, locations, timings, or other characteristics associated with completing the task. Individual users may provide these insights as inputs at critical points during the task lifecycle, or after task completion, to describe how synergies of record values led to certain intermediate or final outcomes for the task.

Whether or not a task is completed, narratives about the task, the task's characteristics, and/or progress towards completing the task may be useful when evaluating the task and other tasks. Such information may be shared with other users to provide insight into how similar tasks may be completed, or what might have been different about a particular task to cause the particular task to be completed faster than other tasks, slower than other tasks, similarly to other tasks, differently from other tasks, or not completed at all. For example, users trying to complete other tasks having similar characteristic(s) or involving similar entit(ies) may use the insight(s) to improve a quality, efficiency, or accuracy of performance of the other task(s).

In some scenarios, narratives are generated by users even after the task is completed to document the task completion or details about how the task was completed. Such narratives may be useful for others attempting to complete other tasks. However, after a task has been completed, there is little motivation for the user primarily responsible for the task, and even less motivation for other users, to proceed with documenting a narrative about the task completion. To promote growth in task completion, performance-based rewards are often based on task completion rather than supplemental documentation. As a result, the additional narrative information is often unrewarded and unavailable and, even if available, may be of low enough average quality that the narrative information is difficult to rely on.

### Custom Fields, Statuses, and Action Triggers

In various embodiments, Opportunity objects or other task-related objects may include field(s) that describe a task or sub-task and/or reference parties or other characteristic(s) of the task or sub-task. The object may include custom fields, such as a “Why Buy” field that defines why a partner would pursue a partnership with an actor pursuant to the task. The custom fields may be configured to create new profile options to map fields such as the “Why Buy” field to custom fields, define an output format, and create a smart action such as a smart action to generate a narrative. The application may be extended to display the custom field(s) and generated narrative on foldout or details pages.

In one example, custom field(s) may be created in an application composer to hold narrative(s), and smart action(s) may be triggered on field(s) to populate value(s) for narrative(s). In a particular example, once an application administrator has logged in, the application administrator may use an application composer to create the custom fields, for example, in a sandbox environment. Once the custom fields are created, the sandbox may be published to the production environment. In a particular example, the following custom fields may be created:
Why Buy Now:
   Data Type—Text and set length to around 1500 characters
Why Buy Company or Why Buy<Vendor Name> (e.g., Oracle, Supremo Software or Microsoft)
   Data Type—Text and set length to around 1500 characters
Why Buy Anything
   Data Type—Text and set length to around 1500 characters
Win Loss Reason
   Data Type—Text and set length to around 1500 characters
Generated Win Story
   Data Type—Long Text

Once the custom fields have been created, the application composer may be used to create a smart action. For example, within the sandbox, a smart action may be created. A display label for the smart action may be assigned, such as “Generate Win Story,” and “Opportunity” or another task-related object may be selected as the object. The application composer may provide an option to select any applications where the smart action should be available (e.g., Workspace, Sales, and on List Pages, etc.), and these applications may be listed when creating the smart action. A path may be specified for a REST API that uses the POST method to write narratives to the specified object.

The application composer may also provide an option to specify conditions for which roles the smart action is made available. Such roles may be specified to ensure that user(s) intended to be able to trigger or refresh the narrative generation script may be allowed to use the smart action while preventing other users from being able to trigger or refresh the narrative generation script. The condition(s) may also specify when the script is available to run, either manually or automatically. For example, a condition may specify “Status==“Won”” to indicate that the script automatically runs when the status changes to “Won” and/or that the smart action is available to run manually via the UI as long as the Status is “Won.”

In a particular example, the application composer may be used to specify parameters of the Request body to be used for the REST API. For example, the Request body parameters may include:
Path as a static value or reference to the LLM or the location of the LLM for passing in prompt information.
Opty_number or “Opportunity Number” or other task ID for identifying a particular task from the Opportunity or other task-related object.
Email address for email functionality. Alternatively, the task management system may use the email address of the logged in user as the email address to send a generated narrative for review, if the workflow includes sending email.
From “Smart Action” or another labeled source that indicates the narrative generation is being triggered by a smart action or other source.

The application composer may provide a further option to specify a name, label, and/or message for a button or graphical option for triggering the narrative generation. For example, the user may specify a name of “Win_Story_Button,” a label of “Generate Win Story,” and a message of “Congratulations on your win! Now, generate a win story to share with the team.” A secondary message may be specified as, for example, “The generated win story will be emailed to you.” A confirmation message may be specified as “Request submitted. Win story will be emailed to you shortly.”

In a specific example, the REST API to generate a narrative may be called at a path “/narrativeRestAPI/AI/callllm” with a method of POST. In the example, the REST API request body parameters may be: template_path of type static and value “/templates/rest/generateWinStory”, task_number of type attribute and value matching the task ID, and from of type static and value of “SmartActionWithFilters”.

The application may also include options for enabling automated application-driven access to make changes to the custom fields to hold the generated narratives. In one specific example, a profile option may be specified as:
a. Profile Option Code: ZCA_WHY_BUY_ANYTHING
b. Profile Option Display Name, set as a meaningful name
c. Application: Common CRM
d. Module: CRM Infrastructure Component
e. Start Date: set as today or a day in the past
f. Mark the profile option as enabled and updateable at site and/or user level.

In the example, other profile options may be created for other field(s) to be included in the narrative, such as:
a. ZCA_WHY_BUY_ANYTHING, for an option to map to a why buy anything field
b. ZCA_WHY_BUY_NOW, for an option to map to a why buy now field
c. ZCA_WHY_BUY_VENDOR, for an option to map to a why buy vendor field
d. ZCA_WIN_LOSS_REASON, for an option to map to a win loss reason field
e. ZCA_SAVE_WINSTORY_TO_FIELD, for mapping to a field for saving the generated narratives
f. ZCA_GENERATE_OUTPUT_FORMAT, for specifying output format for generated narratives

Various examples provided herein include a few narratives generated based on a few fields. The techniques described herein may be extended to generate any number of narratives based on any number of fields. Narratives may be stored in custom field(s) and/or standard text field(s) and may be based on custom field(s) and/or standard field(s). In one embodiment, narratives may also be based on real-world information such as a stock ticker price corresponding to an entity, a quarterly revenue reported for the entity, or any other information that may be retrieved and included in a prompt to the LLM or otherwise used by the LLM to generate a narrative.

In the example, administrator profile values may be managed to set values for the profile option(s) above, such as:
a. ZCA_WHY_BUY_ANYTHING: Internal API name (e.g., WhyBuyAnything_c) for the custom field created above that hold Why Buy Anything field value
b. ZCA_WHY_BUY_NOW: Internal API name for the custom field created above that hold Why Buy Anything field value
c. ZCA_WHY_BUY_VENDOR: Internal API name for the custom field created above that hold Why Buy Anything field value
d. ZCA_WIN_LOSS_REASON: Internal API name for the custom field created above that hold Why Buy Anything field value
e. ZCA_SAVE_WINSTORY_TO_FIELD: Internal API name for the custom field created above where the generated win story should be saved.
f. ZCA_GENERATE_OUTPUT_FORMAT: Specify the format of the Win Story desired e.g. Business Challenge<Please provide your Business Challenge>Value Proposition<Please provide your Value Proposition>Expected Business Results<Please provide your Expected Business Results>Why Supremo Software<Please provide your Why Supremo Software>Sales Process<Please provide your Sales Process>Sales Challenges<Please provide your Sales Challenges>Strategic Importance<Please provide your Strategic Importance>Competition Strategy<Please provide your Competition Strategy>

Each of the options may be enabled and/or made updateable at the site-level, at the product level, and/or at the user-level, such that different options may be applied the same or differently across different users, different sites, or different products.

### Large Language Models Providing Narratives

Large language models (LLMs) may be prompted to provide narratives based on data from task record(s) and other data available in the database. Although LLMs receive unstructured natural language input, the output may be structured or guided by the input to include certain sections, certain topics, or to draw certain conclusions. The narratives may result from ingesting the input data from the task record(s) with targeted goals or sub-goals that are communicated to the LLM via natural language in a consistent format to produce results consistently targeted to the goals or sub-goals and that may be further validated for consistency with the goals or sub-goals and/or the formatting to be consumed by downstream application(s).

Techniques described herein may use a single LLM or multiple LLMs in combination. The LLMs may be selected from any available LLM for processing natural language queries and producing natural language results. For example, the LLM may be GPT-3, GPT-3.5, GPT-4, GPT-40, Cohere, Claude 3, Gemini, BERT, Ernie, Falcon 40B, Gemma, Lamda, Llama, Mistral, Orca, Palm, Phi-1, StableLM, Vicuna 33B, etc. The large language models use transformer models trained to translate, predict, and generate text for large datasets so the model can process and response to natural language queries. The transformer models include encoders and decoders that tokenize textual input or input of other modalities (audio, video, or image) to extract vector embeddings of the input for further processing. The model discovers patterns in the input data that can be used to predict output data. The models are trained with training data and validation data from large datasets such as Wikipedia, GitHub, technical articles or journals, news outlets, blogs, social media posts or feeds, or other encyclopedias or ontologies. The models may be tuned for specific tasks with additional training data and validation data from additional datasets, and may be further tuned with specific examples provided to the LLM via prompts with instructions on how to treat the specific examples.

Various models may look forward or backward in the surrounding context, such as a same sentence or paragraph, to learn the likely concept represented by a token of input. A recurrent layer of a neural network may account for a sequence of the words in the surrounding context to capture more precise meaning. Vector embeddings of the input may be provided to other layers of the neural network trained to process the vector embeddings and detect patterns or draw probabilistically-backed conclusions from the vector embeddings. A feedforward layer of the neural network may transform input embeddings into output embeddings at a different level of granularity for drawing conclusions about varying levels of abstraction that reflect the semantic meaning of the input. These output embeddings may be further consumed by other layers of the neural network to draw conclusions about different aspects of the input. An attention mechanism may be trained to look for specific signals or portions of the input at various layers to draw specific conclusions relevant to an identified specialized purpose of the input.

Some LLMs are plug-and-play, such as ChatGPT and Cohere, which are accessible in pre-trained or continuously trained forms that may be called using existing application programming interfaces (APIs) that allow the model to begin providing results with or without further training. In a specific example, the OpenAI ChatGPT models are trained, tuned, and continuously updated to provide responses using reinforcement learning with human feedback. In another specific example, the Cohere models may be trained and tuned on public and/or private datasets and may be configured to provide more factually rooted responses or more creative responses.

Various LLMs may be called using published application programming interfaces (APIs) that provide a mechanism for including a prompt to the LLM and receiving a response from the LLM. Some APIs also provide a mechanism for providing metadata to the LLM, which serves as additional language to include with the prompt for tailoring the output to overlapping goals of multiple prompts. For example, the metadata may include additional guidelines for the LLM to avoid providing certain types of outputs, or to provide the outputs in a certain format that is consumable by a downstream application. The metadata may be attached to the end of the prompt for tailoring the responses to be more consistently formatted and use consistent background assumptions.

### Prompt Templates

Different application interfaces may be in use by different users, groups of users, or tenants or entities including groups of users. Different application interfaces for different users may involve different narratives to be generated. In one embodiment, an application or user of the application provides an example prompt for generating an example narrative as well as tools for customizing the narrative. The tools for customizing the narrative may cause changes to the prompt, resulting in changes to the narrative.

The narrative may be generated using a prompt template that is used and re-used to generate prompts that are consistent in some aspects but different in others to generate different narratives that may also be consistent in some aspects. A prompt template may include example characteristic(s) to use in the prompt, which may be customized resulting in new prompts for different value(s) of the characteristic(s). In a specific example, default characteristic(s) that may be included are:
why the partner would benefit, is benefitting, or did benefit, or not, from partnering in a particular category of the task,
why the partner would benefit, is benefitting, or did benefit, or not, from partnering with a particular actor of the task,
why the partner would benefit, is benefitting, or did benefit, or not, from partnering immediately or at a particular time to complete the task rather than completing the task at a later or indefinite time,
why the partner chose to partner or not with the particular actor in the particular category to complete the task at the particular time,
problems or other challenges that are present or were partially or wholly solved,
solutions to the problems or other challenges,
value propositions of completing the task,
expected results of completing the task,
what happened uniquely to this task or non-uniquely to this task that is most closely or distantly associated with, correlated or anti-correlated with, detected in a same or similar pattern as other tasks with the same outcome as the task, or detected in a different pattern as other tasks with a different outcome than the task, and/or
any other description(s) or other characteristic(s) that are relevant to the task, completion or non-completion of the task, timeliness of the task, choices in who was involved in the task, what the task entailed, when the task was completed, where the task was completed, why the task was pursued, how the task was approached or performed, and/or to what extent the task differed from or was similar to other tasks with similar or different characteristic(s).

Such characteristic(s) may be ingested and/or generated by the LLM. For example, the LLM may receive, via the prompt, a request to generate a narrative about what happened uniquely for this task based on knowledge of similar tasks such as those tasks learned from large public repositories that were used to train the model. In a particular example, the prompt may request a narrative with sections corresponding to the following sections, some but not all of which may also be provided via field(s) of the record that are already populated with values:
why the partner would benefit, is benefitting, or did benefit, or not, from partnering in a particular category of the task,
why the partner would benefit, is benefitting, or did benefit, or not, from partnering with a particular actor of the task,
why the partner would benefit, is benefitting, or did benefit, or not, from partnering immediately or at a particular time to complete the task rather than completing the task at a later or indefinite time,
why the partner chose to partner or not with the particular actor in the particular category to complete the task at the particular time,
problems or other challenges that are present or were partially or wholly solved,
solutions to the problems or other challenges,
value propositions of completing the task, and/or
expected results of completing the task.

The LLM may be asked to fill in those sections that are not provided based on the information from the other sections that are provided, for example, based on data from the task record(s) for which the narrative(s) are being generated. For example, a problem and solution may be gleaned from information about why the partner would benefit from partnering with the particular actor over other actors and/or from why the partner would benefit from partnering at a particular time. In a particular example, the information about why the partner would benefit from partnering with the particular actor over other actors may include information about the higher level of data security provided by the particular actor, which is needed to protect health data of the partner. The LLM may glean a challenge from this information of “protecting sensitive health data,” and a solution from this information of “providing a higher level of data security than competitors.” The challenge and solution may be further detailed based on information gleaned from other populated field(s) in the record.

The prompt may lay out a template for providing the information, with section headers corresponding to the sections above or other delineated sections. The desired format of the results may be customized via the user interface by dragging the sections to different parts of the template, adding or removing sections corresponding to field(s) of the record or related record(s), adding fixed headers or other static portions of text to the template via user input, and providing the data for some of the sections.

An example prompt may include the following:

### Example Prompt

“Generate a customer win story for Supremo Software where customer is Acme Corp based on the following:
Why buy anything?
They want to apply generative AI to “supercharge” their intent-based marketing tools by adding more automation, leveraging data points via ML algorithms to automate outreach to their Target marketing list, etc.
Why buy now?
They need the integration before the end of the month. This is an urgent request. Customer has global launch and they would like to showcase this integration of generative AI with marketing.
Why buy Supremo Software?
Our Generative AI services portfolio+Microsoft partnership is now very attractive and can do what Acme wants to do with AI.
Win/loss reason?
Business Challenge
<Please provide your Business Challenge>
Value Proposition
<Please provide your Value Proposition>
Expected Business Results
<Please provide your Expected Business Results>
Why Supremo Software
<Please provide your Why Supremo Software>
Sales Process
<Please provide your Sales Process>
Sales Challenges
<Please provide your Sales Challenges>
Strategic Importance
<Please provide your Strategic Importance>
Competition Strategy
<Please provide your Competition Strategy>”

The example prompt may be stored as a prompt template, as follows.

### Example Prompt Template

“Generate a customer win story for {static.companyName} where customer is {TargetPartyName} based on the following: Why buy anything? {WhyBuy Anything_c} Why buy now? {WhyBuyNow_C} Why buy {static.companyName}? {Why BuyCompany_c} Win/loss reason? {WinLossReason_c} Business Challenge<Please provide your Business Challenge>Value Proposition<Please provide your Value Proposition>Expected Business Results<Please provide your Expected Business Results>Why {static.companyName}<Please provide your Why {static.companyName}>Sales Process<Please provide your Sales Process>Sales Challenges<Please provide your Sales Challenges>Strategic Importance<Please provide your Strategic Importance>Competition Strategy<Please provide your competition strategy>”.

In the example, the template includes placeholders for the company or actor's name stored in the {static.companyName} field, the partner or candidate partner's name stored in the {TargetPartyName} field, the existing value for the Why buy anything question, stored in the {Why Buy Anything_c} field, the existing value for the Why buy Supremo Software question, stored in the {WhyBuyCompany_c} field, and the existing value for the Win/loss reason question (e.g., a blank value in the example), stored in the {WinLossReason_c} field. The field values for different tenants in different use cases may be retrieved from database storage and used to populate the placeholders in the template to generate the prompt. The template may be modified by moving the placeholders within the surrounding static text, or by adding or removing placeholders.

In one embodiment, the static text of the prompt may include static guideline(s) for the large language model to avoid offensive language and/or to avoid creating facts other than what is provided in the prompt. Such static guidelines may be helpful for generating narratives in a business context where offensive language or hallucinated facts could be detrimental to the effective and productive consumption of the narratives. In one embodiment, generated narratives may be processed to determine if the generated narratives have any offensive language or any facts that were not present in the inputs. Such processing to find hallucinated facts may be performed by another round-trip with the LLM prompting the LLM to determine whether any facts from one set of information (e.g., the narrative) are not present in the other set of information (e.g., the field value(s) feeding into the narrative). Added fact(s) may be removed from the narrative, either by filtering or by prompting the LLM to rephrase the narrative without including the removed fact(s). Such processing to find offensive language may be performed by asking the LLM to determine whether any language in the narrative would be offensive to an ordinary business person and, if so, to remove the offensive language or rephrase the narrative to exclude the offensive language.

In one embodiment, the task management system determines whether value(s) of the task record(s) to be included in the prompt template via the placeholder(s) satisfy one or more data exclusion conditions, such as whether the values occur on a blacklist of offensive language, match a regular expression of personally identifiable information (PII), or include specific dollar amounts when specific dollar amounts are excluded by policy. If the task management system determines that any of the value(s) satisfy the data exclusion condition(s), the condition-satisfying values may be excluded from the prompt even though the user-modifiable template has placeholder(s) for characteristic(s) that would have otherwise included the value(s).

In one embodiment, a task management system causes display of a user interface including a user-modifiable template that shows placeholder(s) for field(s), the value(s) for which may be substituted to generate a prompt for consumption by the LLM. The placeholder(s) may be included among static text of the prompt template, and the placeholder(s) may refer to variable(s) of the task record(s) or other record(s), for example, using variable name(s). In a particular embodiment, the placeholder(s) are displayed as movable graphical objects within the modifiable static text, such that the movable graphical objects can be dragged, for example, using a mouse or touchscreen input, from one location to another location within the prompt template without requiring input to retype the dragged placeholder. Such an interface allows efficient reconfiguration of prompt templates by the user to produce customized narratives based on the specific text structure set forth by the user.

In one embodiment, once a placeholder has been typed with the delimiter(s) (e.g., “{” and “}” in the example) and matches an existing object in the database, the placeholder may be dragged around the template as a selectable and draggable object even though the placeholder was initially typed in as text. For example, the text may be transformed into the draggable object when the delimiters are completed in text form and the contained text references a valid field. Transformation into the draggable object when the text matches an expected format and when the text references an existing field using a recognized name allows the user to receive instantaneous feedback that the referenced record was found by the task management system. The placeholder may also be colored differently than the surrounding static text, such as “based on the following: Why buy anything?” The placeholders may also be toggled between values obtained from an example record (e.g., “Acme”) and variable names (e.g., “TargetPartyName”) by clicking on the placeholders to see how data is filled using an example record. All placeholders in the template may be toggled together to show values of a sample record or variable names.

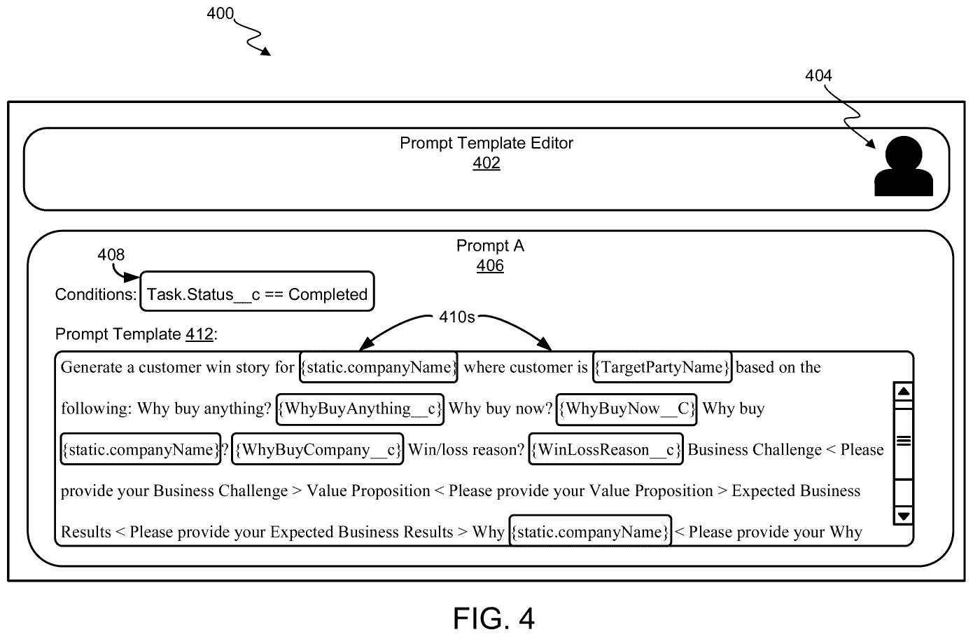

FIG. 4 illustrates a diagram of an example user interface 400 showing a user-modifiable prompt template 412 specific to a prompt 406 triggered based on condition(s) 408 to prompt LLM(s) for generating narrative(s) about why condition(s) are satisfied. As shown, prompt template 412 includes draggable objects 410s corresponding to placeholders that may be dragged around to different locations within prompt template 412. Also as shown, condition(s) 408 include Task. Status_c==Completed, indicating that the prompt 406 triggers to fill in the placeholder values, retrieve a result from the LLM, and fill in a field of the task record when the task status is newly marked as completed.

Referring back to the example prompt with reference to the example prompt template, upon substitution of the placeholder values, the “Why buy Supremo Software” field has been provided in the prompt as “Our Generative AI services portfolio+Microsoft partnership is now very attractive and can do what Acme wants to do with AI.” This field may be provided as-is or may be modified to be in sentence form with proper grammar, spelling, and punctuation, depending on the instructions to the LLM.

Also in the example, the “Sales Process” field has not been provided in the prompt. The LLM will glean details from the other provided fields to fill in the Sales Process with any relevant information. In the example, the LLM may include a “Sales Process” section that says:
“Sales Process:
Our sales team at Supremo worked closely with Acme Corp to understand their specific needs and challenges. We then demonstrated our Generative AI capabilities and showcased successful case studies and testimonials to emphasize the value we bring to the table.”

As shown, when generating the Sales Process section, the LLM pulled information from “Why buy anything?” as “Generative AI” and “‘supercharge’ their intent-based marketing tools” “adding more automation” and used this information when generating “understand their specific needs and challenges” and “ . . . demonstrated our Generative AI capabilities . . . ”. The LLM also pulled information from “Why buy now?” as “urgent request,” “global launch,” “showcase this integration,” and “generative AI” and used this information when generating “understand their specific needs and challenges,” demonstrated our Generative AI capabilities,” “showcased successful case studies and testimonials,” and “emphasize the value we bring to the table.” The LLM also pulled information from “Why buy Supremo Software?” as “Generative AI services,” and “can do now what Acme wants to do with AI,” as “demonstrated our Generative AI capabilities,” “showcased successful case studies and testimonials,” and “emphasize the value we bring to the table.”

In various examples, field value(s) from the task record(s) describe interaction(s) between a team of one or more actors and a candidate partner related to the task. The modifiable text may include section header(s) of blank section(s) to be completed by the LLM, and the LLM may fill in the section(s) by summarizing the interaction(s) from the field value(s) to address a topic of the section header(s) as gleaned by the LLM from the section header(s) themselves.

In one embodiment, the prompt includes an example of another task completion narrative that is based on other information potentially unrelated to the task or task record of a given prompt. For example, the other information may be from another task record for which another narrative was manually or automatically generated, and the example may provide the other information and the resulting narrative as an example of what a well-formed narrative should look like. The other information used as an example may include other values for the same or different characteristics that are involved in generating a narrative based on a prompt template for a given record.

Referring back to the example prompt, the full output of the LLM based on the example prompt, which was generated based on the template, may be as follows:

### Example LLM Output

“Certainly, here is a draft of a customer win story for Acme Corp based on the information provided:
**Business Challenge:** Acme Corp is seeking a more efficient way to leverage data points and add more automation to their intent-based marketing tools. They wish to implement generative AI into their systems to help achieve this.
** Value Proposition:** By choosing Supremo Software, Acme Corp will have access to our portfolio of Generative AI services coupled with our strong partnership with Microsoft. This will allow them to achieve the automation and integration of AI technology with their marketing systems, adding a powerful boost to their performance.
** Expected Business Results:** By integrating generative AI with their marketing, Acme Corp will be able to automate more processes, ultimately saving time and resources in the long run. This will also allow for more effective marketing campaigns, leveraging data points and ML algorithms to reach the desired target audience.
** Why Supremo Software:** Supremo's Generative AI services portfolio, coupled with our expertise and partnership with Microsoft, positions us as the ideal choice to help Acme Corp achieve their goals. Our capabilities align perfectly with the needs of Acme Corp, making us a reliable and trustworthy partner.
** Sales Process:** Our sales team at Supremo worked closely with Acme Corp to understand their specific needs and challenges. We then demonstrated our Generative AI capabilities and showcased successful case studies and testimonials to emphasize the value we bring to the table.
** Sales Challenges:** Acme Corp had an urgent request to integrate the AI services before a global launch. Our team worked diligently to expedite the process, ensuring a smooth and timely implementation.
** Strategic Importance:** This partnership with Acme Corp solidifies Supremo's position as a trusted provider of Generative AI services. It also allows us to expand our reach within the marketing industry and demonstrates our ability to deliver impactful solutions.
** Competition Strategy:** Our key differentiator was our extensive partnership with Microsoft and our ability to tailor our Generative AI services to Acme Corp's specific needs in the marketing sphere. This, coupled with our efficient and customer-centric approach, helped us stand out from potential competitors.”

### Intelligently Persisted Task Narratives

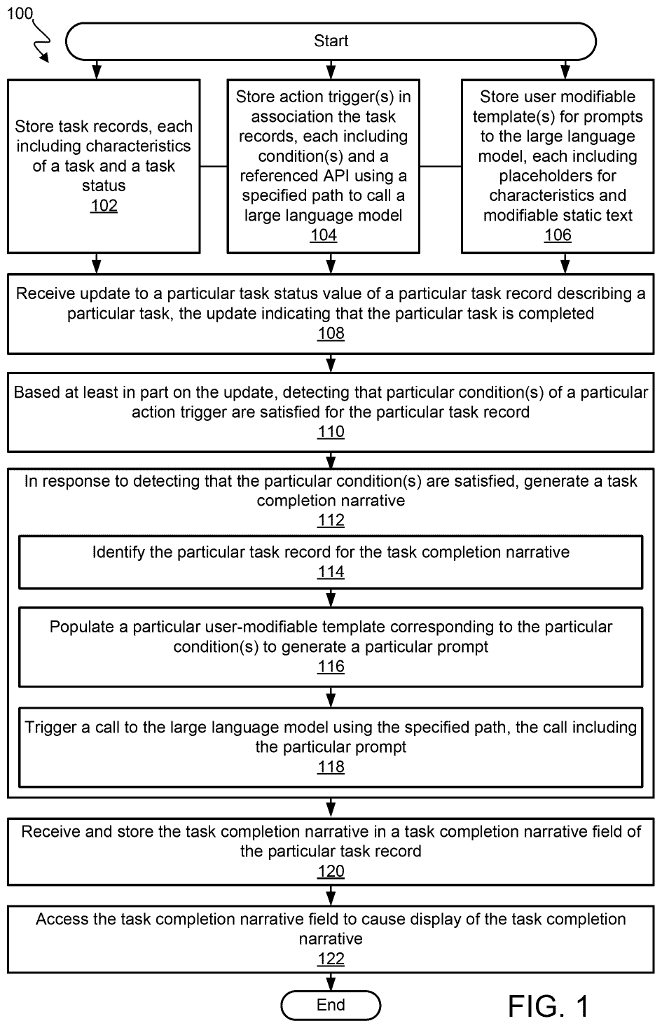

FIG. 1 illustrates a flow chart of an example process 100 that detects condition(s) are satisfied with respect to task record(s), and triggers action(s) including substituting information from the task record(s) into placeholder(s) of user-modifiable template(s) to prompt LLM(s) for generating narrative(s) about how the condition(s) were satisfied. As shown, process 100 begins in blocks 102, 104, and/or 106. In block 102, task records are stored, each task record including characteristics of a task and a task status. In block 104, action trigger(s) are stored in association with the task records, each action trigger including condition(s) and a referenced API using a specified path to call a large language model. In block 106, user-modifiable template(s) are stored for prompts to the large language model, each user-modifiable template including placeholders for characteristics and modifiable static text.

In block 108, the task management system receives an update to a particular task status value of a particular task record describing a particular task. In the example shown, the update includes that the particular task is completed. Based at least in part on the update, the task management system detects that particular condition(s) of a particular action trigger are satisfied for a particular task record in block 110. In response to detecting that the particular condition(s) are satisfied, the task management system generates a task completion narrative in block 112.

Generating the task completion narrative may include several sub-steps as shown in block 112 of FIG. 1. In block 114, the task management system identifies the particular task record for the task completion narrative. For example, the particular task record may be identified by a request from a user interface component for viewing information about the particular task record, and an identifier of the particular task record may be passed in from the user interface. As another example, the identifier may be determined based on which task record satisfied other condition(s) for triggering the narrative generation.

The sub-steps continue in block 116, where the task management system populates a particular user-modifiable template corresponding to the particular condition(s) to generate a particular prompt. Then, in block 118, the task management system triggers a call to a large language model (LLM) using the specified path. The call includes the particular prompt that was generated. The LLM completes generation of the task completion narrative based on the prompt, for passing back to the task management system, for example, according to an API that supports requests and responses to and from the LLM.

In block 120, the task management system receives and stores the task completion narrative in a task completion narrative field of the particular task record. The task completion narrative field may be accessed in block 122 to cause display of the task completion narrative.

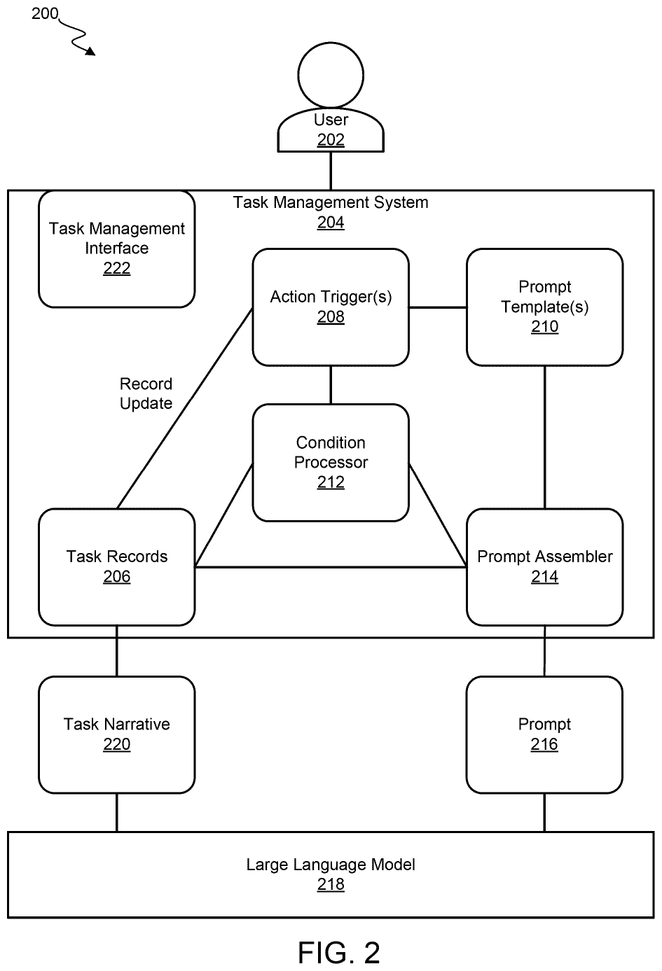

FIG. 2 illustrates a system diagram showing an example system 200 that detects condition(s) are satisfied with respect to task record(s), and triggers action(s) including substituting information from the task record(s) into placeholder(s) of user-modifiable template(s) to prompt LLM(s) for generating narrative(s) about why the condition(s) were satisfied. As shown, system 200 includes task management system 204 for managing task records 206 using action trigger(s) 208 including condition(s) such as condition(s) that are evaluated when a record is updated. The condition(s), when satisfied as determined by condition processor 212, cause prompt template(s) 210 to be used by prompt assembler 214 to generate prompt 216 for sending to large language model 218. Large language model 218 generates a task narrative for sending back to task management system 204 and inclusion in a corresponding task record of task records 206. For example, task narrative 220 may be received and stored in a particular field of task record 206. The task narrative may then be retrieved from task records 206 for inclusion in task management interface 222, which causes display of information to user 202, such as on a client device of user 202.

In one embodiment, a narrative for a task or record may be generated using a generative artificial intelligence model in response to a request from a user to generate the narrative. In another embodiment, the narrative is generated automatically with or without the preceding request, optionally according to a schedule, periodically, in response to a status change of a record, or any other event where value(s) of record(s) satisfy certain condition(s). In one embodiment, the narrative for a task or record is generated using a generative artificial intelligence model, such as a large language model (LLM), based at least in part on an automatically generated prompt to the generative artificial intelligence model that includes characteristic(s) unique to the record, characteristic(s) that the record has in common with other records, and fixed or otherwise static instructions. The generative artificial intelligence model may generate, in response to the prompt, a narrative specific to the record for updating a field of the record to persist the narrative for use in user interface(s), report(s), dashboard(s), automatically generated slideshow(s), audio clip(s), movie(s), or other downstream content based on the narrative.

In one embodiment, a task management system uses generative AI to generate a narrative when a task satisfies certain conditions, such as becoming closed or completed. The narrative may then be shared with users in the organization to educate the users, for example, about how tasks can progress to satisfy the certain conditions.

In one embodiment, different narratives are generated for different purposes in response to a request, according to a schedule, periodically, in response to a status change of a record, or any other event where value(s) of record(s) satisfy certain condition(s). The different narratives may detail different aspects of the task and optionally use different characteristic(s) unique to the record, different characteristic(s) that the record has in common with other records, and/or different fixed or otherwise static instructions specific to the different purposes. For example, the narrative may explain any of the following aspects of the task, any of which may be manually generated or automatically generated (e.g., based on formulas that combine other fields) to feed into the narrative:
why the partner would benefit, is benefitting, or did benefit, or not, from partnering in a particular category of the task,
why the partner would benefit, is benefitting, or did benefit, or not, from partnering with a particular actor of the task,
why the partner would benefit, is benefitting, or did benefit, or not, from partnering immediately or at a particular time to complete the task rather than completing the task at a later or indefinite time,
why the partner chose to partner or not with the particular actor in the particular category to complete the task at the particular time,
problems or other challenges that are present or were partially or wholly solved,
solutions to the problems or other challenges,
value propositions of completing the task,
expected results of completing the task,
what happened uniquely to this task or non-uniquely to this task that is most closely or distantly associated with, correlated or anti-correlated with, detected in a same or similar pattern as other tasks with the same outcome as the task, or detected in a different pattern as other tasks with a different outcome than the task, and/or
any other description(s) or other characteristic(s) that are relevant to the task, completion or non-completion of the task, timeliness of the task, choices in who was involved in the task, what the task entailed, when the task was completed, where the task was completed, why the task was pursued, how the task was approached or performed, and/or to what extent the task differed from or was similar to other tasks with similar or different characteristic(s).

In one embodiment, a subset of one or more characteristic(s) may be gathered from users at various points in the lifecycle of the task. At checkpoint(s) during task completion, input(s) may be requested from user(s) based on a stored user assignment between the user(s) and the task. The input(s) may provide different characteristics at different times or checkpoints as the task is carried out or when the task is completed. For example, any of the following possible checkpoints may trigger requests for user input to fill in characteristic(s):
when the task is created,
when a sub-task is initiated,
when a sub-task is completed,
when a metric quantifying task progress reaches a relative or absolute threshold,
when a metric quantifying predicted or a likelihood of task progress reaches a relative or absolute threshold,
when a metric quantifying a predicted checkpoint completion date reaches a relative or absolute threshold,
when a metric quantifying likelihood of task completion reaches a relative or absolute threshold,
when a metric quantifying a value of partial task completion reaches a relative or absolute threshold,
when a metric quantifying a predicted value of task completion reaches a relative or absolute threshold,
when a metric quantifying a value or amount of partial resources consumed to complete the task reaches a relative or absolute threshold,
when a metric quantifying a predicted value or amount of resources consumed to complete the task reaches a relative or absolute threshold,
when the task is completed, abandoned or rejected, or closed, or the status of the task otherwise changes, and/or
after an amount of time has passed since task creation, completion, or any other checkpoint, potentially including a previous iteration of this time-based checkpoint or any other checkpoint.

In one embodiment, the prompt to the LLM requests the LLM to make inferences to connect facts from the characteristic(s) of the task record, such as unique characteristic(s) and/or characteristic(s) in common with other task records, and/or any other details about interactions with a partner or other entity involved in task completion, in order to generate the narrative, and the narrative includes the inferences based on the connected facts from different characteristic(s) or other details from the task record.

In one embodiment, narrative generation is triggered in response to a request, according to a schedule, periodically, in response to a status change of a record, or any other event where value(s) of record(s) satisfy certain condition(s). If triggered periodically or according to a schedule, the narrative generation may apply to any record(s) that have changed to a target status (e.g., “completed,” “abandoned,” “rejected,” or “closed”) or that have newly satisfied certain condition(s) within the period of time, to newly generate or refresh previously generated narratives based on the update(s) to the record(s).

A task management system may generate a narrative using an application programming interface (API) that is called using a path that identifies a location of the API. The API may receive a prompt template or a reference to a prompt template, for example, which may be stored in a designated location or otherwise referenced in the request. The API may also receive the object for which the narrative is requested. For example, the specified object may identify a task database structure for which a narrative is requested. The API may receive record identifier or a reference to a record of the task database structure for which the narrative is requested. The API may also receive an email subject to use for sending the narrative, if sending the narrative via email. The API may also include an email address to which the narrative is sent, or the API may default to the email address of the user requesting the narrative if a user is logged in to request the narrative. The API may also receive passed in field values, such as “static.companyName=Supremo Software”, for which fields may be referenced in the prompt template.

Based on the information received in the API, the task management system may retrieve a stored template and fill in values based on the passed in field values and the field values retrieved from the record referenced in the API request. For example, the Example Prompt Template may be filled in to form Example Prompt, which is submitted to the LLM to generate an Example LLM Output. The Example LLM Output may be stored as a narrative in a corresponding record for use in downstream application functionality, user interfaces, or triggered communications.

In one embodiment, a call is triggered to the LLM based at least in part on determining that the task completion narrative field for a particular task record is blank. A check for whether the task completion narrative field is blank may be performed prior to calling the LLM, and the task completion narrative may be stored in the task completion narrative field to replace the blank value upon receiving the task completion narrative response from the LLM. In one embodiment, the call to the LLM is avoided if the task completion narrative field is not blank. In another embodiment, the call to the LLM is still performed if the task completion narrative field is blank, and the task completion narrative field is refreshed based on an updated result from the LLM. In yet another embodiment, the automated narrative from the LLM may be stored in a backup field if the task completion narrative field is not already blank, and the backup field may be analyzed by a user to see which field should serve as the live task completion narrative for publication to other users. In a particular embodiment, storing the task completion narrative in the task completion narrative field is performed after determining that the task completion narrative field for the particular task record is still blank and has not been filled in by a user or other process while the LLM was responding to the prompt.

In various embodiments, the characteristic(s) or field value(s) feeding into the prompt(s) or otherwise used to generate or process narrative(s) may be stored according to same or different natural languages (e.g., English, Spanish, Mandarin, Hindi, French, Arabic, etc.), and the characteristic(s) or field value(s) may be transformed to a language of a consuming user, which may be a different language that one or more of the characteristic(s) or field value(s) prior to prompting the LLM or as a result of specifying a target language in the prompt to the LLM. For example, in one embodiment, the field(s) or other characteristic(s) feeding into the narrative(s) may be transformed into a target natural language prior to prompting the LLM, and the LLM may be prompted using the transformed characteristic(s) rather than the characteristic(s) stored in the record. A narrative in the target natural language may result from the prompt, and the narrative may be stored in the record in the target natural language. The narrative may be further transformed into other target languages by using the narrative resulting from the LLM as input for transforming the narrative into other target languages. Narrative(s) of target language(s) may be stored in the record(s) and used to provide interactive user interface feature(s) to user(s) based on their language preference(s).

The task management system may detect that some characteristic(s) are in a different language than a target language of the particular prompt. Rather than inputting characteristic(s) of a different language to the prompt, the task management system may transform any characteristic(s) in another language to the target language before including the characteristic(s) in the prompt to the LLM. In another embodiment, the characteristic(s) may be provided in different language(s) than the target language, but the prompt may include a text request added to the prompt requesting that the task completion narrative be provided in the target language.

In one embodiment, the task management system summarizes multiple task completion narratives or other narratives of multiple tasks. For example, the tasks may be grouped on any criteria, such as criteria relating to characteristic(s) of the tasks such as characteristic(s) that are in common or shared among multiple tasks. The narratives of the grouped tasks may be summarized together to provide higher-level insights on tasks such as those having the characteristic(s) in common. The summaries of narratives may be generated by prompting the LLM with task completion narrative fields relating to the different tasks and other modifiable static text requesting the LLM to summarize one or more aspects of the tasks grouped together and/or to summarize the narratives of the tasks that have been grouped together.

In one embodiment, a plurality of narratives in same or different natural languages may be summarized using an additional prompt to the LLM. The prompt may include the narrative from each record or task with a fixed or otherwise static portion of the prompt instructing to summarize the narratives into a single narrative and a variable portion of the prompt specifying a target language for the summarization of the narratives. The prompt may include additional fixed criteria requesting a minimum of nm observations or summarization points for each of m topics, sentiments, scenarios, or other categories of narratives or of topics or tasks covered by the narratives, where nm may vary in number for each such category according to specified criteria in the prompt. Such variations in the summarization points may be configured in the user interface. A summarization field may be determined across all or a subset of tasks in a particular category, that occurred during a particular time period, or that share certain characteristic(s), and such determination may be made in response to a user request for a summary, periodically (e.g., to cover each time period), according to a schedule, or automatically in response to a status change of a record or record(s) or any other event where value(s) of record(s) satisfy certain condition(s).

For example, a prompt to the LLM for a summary of the narratives may request the positive outcomes be quantified, the negative outcomes be quantified, the characteristic(s) in common to the positive outcomes be identified, the characteristic(s) in common to the negative outcomes be identified, and/or the differences or aggregate differences between the positive outcome(s) as a group and the negative outcome(s) as a group be identified or quantified. The prompt may include the narratives or a reference to or excerpt from the narratives. As a result, the LLM may summarize that a majority of the positive outcomes or most commonly occurring clusters of positive outcomes had certain characteristic(s) in common, a majority of negative outcomes or most commonly occurring clusters of negative outcomes had certain characteristic(s) in common, and/or the top-occurring clusters of positive outcomes were most different from the top-occurring clusters of negative outcomes along characteristic(s) identified by the LLM.

### Post-Processing Transformation of Narratives

In one embodiment, the narrative provided by the LLM is further transformed to remove offensive or biased language or other language that references race, gender, sexual orientation, or other information from a protected class, filter out negative sentiment statements from the narrative, and/or remove proper names, individual names, or personally identifiable information (PII) from the narrative.

The task management system may store validation rule(s) in association with the task completion narrative field or in association with all or a group of task completion narrative fields. The validation rule(s) may include constraint(s) on content that can be stored in the task completion narrative field(s), such as constraint(s) on regular expressions or other constraints that may (within maximum size limits or valid character sets, for example) or may not (social security number ###-##-#### or phone number ###-###-####, for example) be stored in the task completion narrative field(s). The task management system may store the task completion narrative after determining that the constraints are satisfied by the narrative, or may reject the narrative for storage if the narrative violates any of the constraints.

In one embodiment, a first version of a narrative is generated for a first group of users in a database. The first version of the narrative may include sensitive or confidential information private to the first group of users and not accessible to other group(s) of users. The LLM may also be prompted to produce a second version of the narrative that filters out information private to the first group of users (for example, customer name(s), email addresses, phone numbers, discount amounts, specific contract values, lengths, or other terms, etc.). The prompt may identify only that information to be included in the narrative, and a filtered narrative may be generated by the LLM as a second version of the narrative to be stored in association with the record and accessible to users other than the first group of users and possibly also the first group of users. The filtered narrative may be a natively generated narrative with filtering occurring before prompting the LLM rather than the original narrative post-processed to remove certain information. For example, existing field(s) that may be sensitive may be detected based on field(s) marked as sensitive or marked as having limited accessibility, and/or based on regular expressions that detect personally identifiable information or other sensitive information such as phone numbers (###-###-####), contact names ([Capital Letter][Other Letters][Space][Capital Letter][Other Letters]), email addresses (*@*.com), social security numbers (###-##-####), dollar amounts ($ #), percentages (#%), etc. In one embodiment, the task management system checks target user(s) that have been identified as candidate recipients for viewing the generated narrative(s), and the task management system may remove, from the narrative, any information that would not otherwise be accessible to the candidate recipients in the task management system. After the sensitive information has been removed, the LLM may be prompted as if this information never existed. Field(s) may be left blank or with default values (e.g., 555-555-5555 for a phone number) if the entire field(s) included sensitive information.

In the same or a different embodiment, the filtered narrative may replace the private information with placeholders after the narrative has been produced by the LLM. In the same or a different embodiment, another prompt to the LLM may request the LLM to rephrase the narrative so placeholder or other markers of sensitive information that have been detected are removed, where the placeholder may be retained in a second version of the narrative. In another embodiment, once the placeholders or markers mark private information in the original narrative, the placeholder-containing narrative may be saved as a second version of the narrative with or without prompting an LLM. Different versions of the narratives may be based on different information and be viewable by different groups of users.

The different versions may also be useful for drawing finer-grained conclusions or coarser-grained conclusions when the versions of the narratives are used as examples, depending on whether the narratives include finer-grained information or coarser-grained information. For example, the narratives may include aggregate quantities of items, resources, or personnel involved in carrying out the task, or may include detailed accounts of each item, resource, or personnel involved in carrying out the task and how and when they were involved. Generated narratives may be accessible based on roles or privileges of different users in the database, such that users in one group cannot see narratives private to another group but can see narratives intended to be published to many groups.

In an embodiment, the task management system checks whether the task completion narrative satisfies any data exclusion condition(s) before storing the task completion narrative in a corresponding field of the task record. For example, an initial task completion narrative may be generated that includes data characteristic(s) that satisfy data exclusion condition(s) applied by the task management system, such as condition(s) to exclude PII or offensive language. After determining that the initial task completion narrative includes data characteristic(s) that satisfy data exclusion condition(s), the task management system may prompt the LLM for a revised task completion narrative that does not satisfy the data exclusion condition(s), for example, by requesting the LLM to remove, from the initial narrative, the data characteristic(s) that led to the condition(s) being satisfied or by removing data from the prompt related to the data characteristic(s) and requesting the LLM to generate a new narrative as if those characteristic(s) never existed.

In one embodiment, narratives are consumed by a quality management system. The quality management system may use the narratives to prompt an LLM to identify any potentially offensive or biased language contained in the narrative or to identify any information that is not literally present in the existing fields that were provided to generate the narrative. For example, the prompt may include the generated narrative and/or the field(s) originally provided to generate the narrative and ask the LLM to identify any facts that were not present in the field(s) originally provided but are present in the generated narrative. Certain generic facts, such as “contacted partner,” “highlighted the potential benefits of a partnership,” or “satisfied the partner's needs” may be whitelisted as facts that are okay to add into the narrative even if not present in the field(s) originally provided. Other facts, such as “visited partner's site,” “built a proof-of-concept,” or “connected partner with existing customers” may be blacklisted unless such facts are specifically mentioned or referenced in the existing field(s) used to generate the narrative. In this manner, hallucinations by the LLM may be mitigated to only those hallucinations that are generic and harmless and not hallucinations that reveal a non-existent but otherwise important fact (such as visiting partners at their sites being done in the sales context) presumed to be present by the LLM.

In one embodiment, if re-prompting the LLM to find added facts reveals that certain hallucinations are common, the prompt template may be updated with metadata that instructs the LLM to avoid making the common hallucinations. For example, the metadata may indicate, to the LLM: “Do not add details about site visits unless site visits are specifically mentioned in the existing fields.”

### Downstream Content Automatically Incorporating Narratives

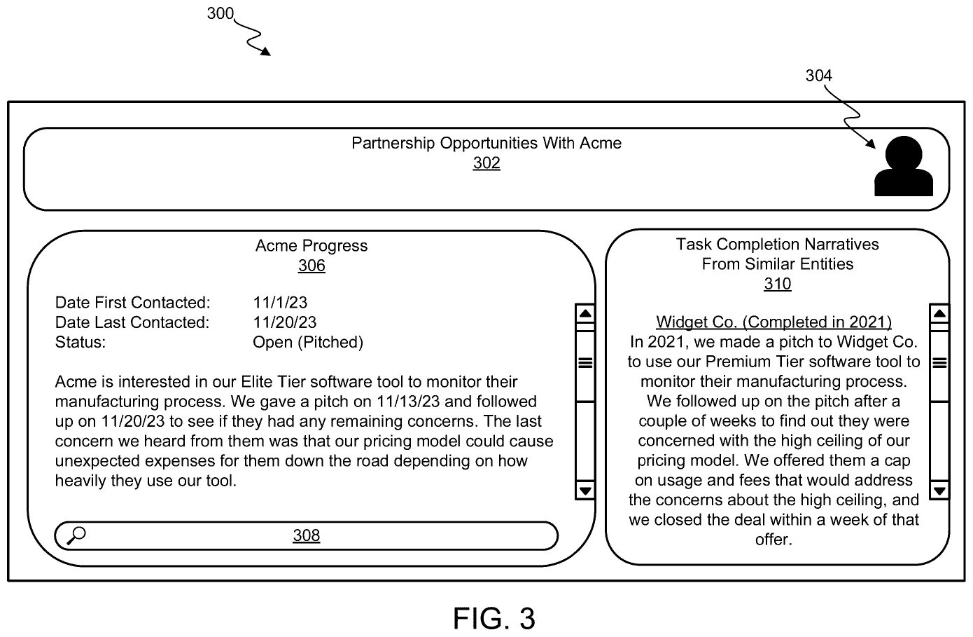

FIG. 3 illustrates a diagram of an example user interface 300 showing a generated narrative in region 310 about why condition(s) were satisfied for an existing task that is similar to a target task, for which details are shown in region 306. As shown, user interface 300 may include a header 302, which identifies a user 304 logged into the task management interface for viewing task details. Search bar 308 may be used to search for specific tasks, which are shown in region 306. For example, the search bar may receive a request for task(s) having particular characteristic(s), leading to the display of the target task. Region 310 may include one or more other tasks that are determined to be similar to the target task being viewed in region 306. For example, similarity may be determined based on Euclidean or cosine similarity between a vectorized representation of a task record relating to the corresponding task and a vectorized representation of a task record relating to the target task. Task records with a closest similarity score may be selected as similar to the target task.

The narrative for a given task record may be persisted for use in comparisons with other task records, or for use in other user interface(s), report(s), dashboard(s), automatically generated slideshow(s), audio clip(s), movie(s), or other downstream content based on the narrative. Reports may include one or more narratives relevant to a topic or characteristic(s) common to task records for which the narratives were generated. Dashboards may include live views of reports or charts based on reports that show quantified metric(s) of how many narratives are available about positive outcomes (for example, completed tasks) or negative outcomes (for example, abandoned or closed but not completed tasks). The relevant portions of the dashboards may be selected to drill-down into the individual records making up the selected quantified metric.

Slideshows may be generated to include sequences of narratives and/or other reports, charts, or other visuals retrieved from the task record or from the LLM based on information in the task record. In one embodiment, slideshows may be supplemented with visualizations that result from prompting the LLM for a corresponding image that is unique to a narrative to appear in the slideshow. The corresponding visualization may be stored in the task record for inclusion in the slideshow or in user interface(s) or other downstream content.

Audio clips and movies may also be generated by the LLM based on the generated narrative. For example, the audio clip may simply be a text-to-speech transformation of the narrative performed by a text-to-speech model that reads text in a selected voice. A video clip may include a simulated avatar delivering the speech, for example. As another example, the audio and/or video clip may include supplemental content such as a simulated interaction between the partner and an actor on the task record, based on information stored in the task record. The simulated interaction or other audio or video content may be stored in the task record as an audio or video file and may be retrieved from the task record for inclusion in the video, a slideshow, or other downstream content.

In one embodiment, the task completion narrative is accessed to cause display of a conditionally rendered user interface component. The conditionally rendered user interface component may be rendered if the task completion narrative field is not blank and hidden if the task completion narrative field is blank. Hiding blank fields may improve useability and efficiency of the task management system.

In one embodiment, an application may be extended to add Why Buy & Win/Loss Reason custom fields on details layouts or other user interfaces of the application that accept user input of values for the custom fields as the interface supports tracking a task. The user interfaces may also show generated narratives that have been created automatically or in response to the user's prompt to create the narratives. For example, a user interface may be extended to display the win story generated on a panel or header, on a details page, or any other place of interest. In a particular example, the narrative may be displayed on a conditional panel that displays the narrative only if the narrative field has a value. Logic for implementing an example conditional panel is shown below.

### Example Conditional Panel

```
<oj-bind-if test=“[[$base.page.variables.row.WinStoryField_c]]”>
  <oj-sp-foldout-panel-summarizing panel-title=“Win Story”>
    <oj-text-area readonly=“true” value=“{{
    $base.page.variables.row.WinStoryField_c }}”
max-rows=“20”></oj-text-area>
    </oj-sp-foldout-panel-summarizing>
</oj-bind-if>
```

In the example, the object is bound to the WinStoryField_c value for the selected row shown on the page. If the row has a value, a foldout “Win Story” panel is shown with the value from the field. The panel may be capped at a certain size (e.g., 20 rows of text) and may or may not allow scrolling if the value exceeds the size.

The panel may be shown in a series of panels, for example, that appear in vertical strips across the screen or horizontal strips down the screen. Panels that have no information may be hidden, and panels that have information may be shown, such that the user may view the screen from left to right or top to bottom to consume the information available without having to scroll past blank panels of information that is unavailable.

In another embodiment, the generated narrative is made available as an API to the task management system. The API may be invoked from another application to cause display of an interface or otherwise cause functionality that uses the generated narrative.

In yet another embodiment, the generated narrative may be pushed to another application or another component of the same application via smart actions, workflows, or triggered communications such as emails or text messages. Once the narrative is generated, the narrative can be published to any repository (e.g., Sharepoint, Sales Accelerator, etc.) where users can search and find such information when working on similar deals in future. The generated narrative may be stored and published to the other applications for consumption by users of the other applications, optionally dependent on stored conditions of the actions or workflows that determine what generated narratives get published downstream and what generated narratives do not get published downstream.

In one embodiment, the task completion narrative field is accessed to cause display of the task completion narrative to at least one actor that may be on a team assigned to handle the task or on another team. In one embodiment, the task completion narrative is displayed on a triggered email communication to at least one other team including at least one other actor that did not handle the task. The task record might not be modifiable to the other actor or any actors on the other team. Publishing the task narratives to other teams may help the other teams understand how to complete similar tasks even if the other teams do not have access to the narrated task in the task management system user interface.

In another embodiment, an email communication may be triggered to a member of the team that handled the task. The email communication may include an interactive option which, when selected, triggers email communication(s) to other team(s). The task record may be modifiable in the task management system by the member of the team but not by the member of the other teams. In this manner, the email communication may provide an efficient reminder for the member of the team and one-click or single-selection option for publishing the task narrative to other teams when convenient. The email may include a selectable task identifier that can be selected by the member of the team to review the task record before deciding whether to publish to other teams, or may include any other identifier of the task record so the reviewing team member knows which task is being summarized by the narrative.

In one embodiment, an automated communication to the team that worked on the task record may include a first version of the narrative that is based on a first set of fields that are accessible to the member(s) of the team receiving the communication, and another automated communication to another team that did not work on the task record may include a second version of the narrative that is based on a second set of fields that are accessible to the member(s) of the other team receiving the other communication. The first set of fields and the second set of fields may be different. For example, the second set of fields may be a subset of the first set of fields that may omit one or more fields that are inaccessible to the other team. In other words, the other communication may omit information from the inaccessible fields when sending a narrative to the other team.

### Computer System Architecture

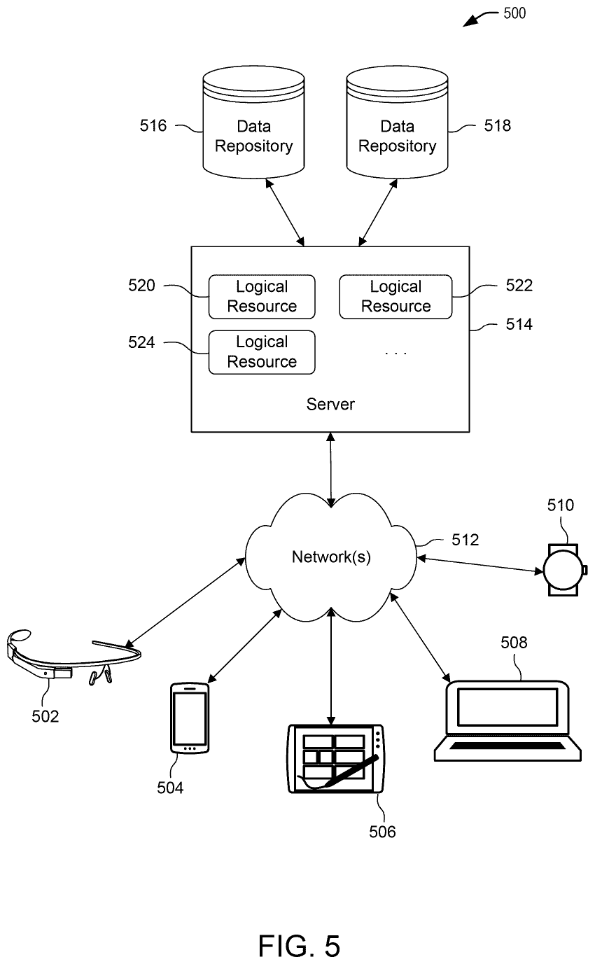

FIG. 5 depicts a simplified diagram of a distributed system 500 for implementing an embodiment. In the illustrated embodiment, distributed system 500 includes one or more client computing devices 502, 504, 506, 508, and/or 510 coupled to a server 514 via one or more communication networks 512. Clients computing devices 502, 504, 506, 508, and/or 510 may be configured to execute one or more applications.

In various aspects, server 514 may be adapted to run one or more services or software applications that enable techniques for managing and generating task completion narratives.

In certain aspects, server 514 may also provide other services or software applications that can include non-virtual and virtual environments. In some aspects, these services may be offered as web-based or cloud services, such as under a Software as a Service (SaaS) model to the users of client computing devices 502, 504, 506, 508, and/or 510. Users operating client computing devices 502, 504, 506, 508, and/or 510 may in turn utilize one or more client applications to interact with server 514 to utilize the services provided by these components.

In the configuration depicted in FIG. 5, server 514 may include one or more components 520, 522 and 524 that implement the functions performed by server 514. These components may include software components that may be executed by one or more processors, hardware components, or combinations thereof. It should be appreciated that various different system configurations are possible, which may be different from distributed system 500. The embodiment shown in FIG. 5 is thus one example of a distributed system for implementing an embodiment system and is not intended to be limiting.

Users may use client computing devices 502, 504, 506, 508, and/or 510 for techniques for managing and generating task completion narratives in accordance with the teachings of this disclosure. A client device may provide an interface that enables a user of the client device to interact with the client device. The client device may also output information to the user via this interface. Although FIG. 5 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome OS) including various mobile operating systems (e.g., Microsoft Windows Mobile®, iOS®, Windows Phone®, Android®, HarmonyOS®, Tizen®, KaiOS®, Sailfish® OS, Ubuntu Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 512 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 512 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 514 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 514 can include one or more virtual machines running virtual operating systems, or other computing architectures involving virtualization such as one or more flexible pools of logical storage devices that can be virtualized to maintain virtual storage devices for the server. In various aspects, server 514 may be adapted to run one or more services or software applications that provide the functionality described in the foregoing disclosure.

The computing systems in server 514 may run one or more operating systems including any of those discussed above, as well as any commercially available server operating system. Server 514 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 514 may include one or more applications to analyze and consolidate data feeds and/or event updates received from users of client computing devices 502, 504, 506, 508, and/or 510. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 514 may also include one or more applications to display the data feeds and/or real-time events via one or more display devices of client computing devices 502, 504, 506, 508, and/or 510.

Distributed system 500 may also include one or more data repositories 516, 518. These data repositories may be used to store data and other information in certain aspects. For example, one or more of the data repositories 516, 518 may be used to store information for techniques for managing and generating task completion narratives. Data repositories 516, 518 may reside in a variety of locations. For example, a data repository used by server 514 may be local to server 514 or may be remote from server 514 and in communication with server 514 via a network-based or dedicated connection. Data repositories 516, 518 may be of different types. In certain aspects, a data repository used by server 514 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 516, 518 may also be used by applications to store application data. The data repositories used by applications may be of different types such as, for example, a key-value store repository, an object store repository, or a general storage repository supported by a file system.

In one embodiment, server 514 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

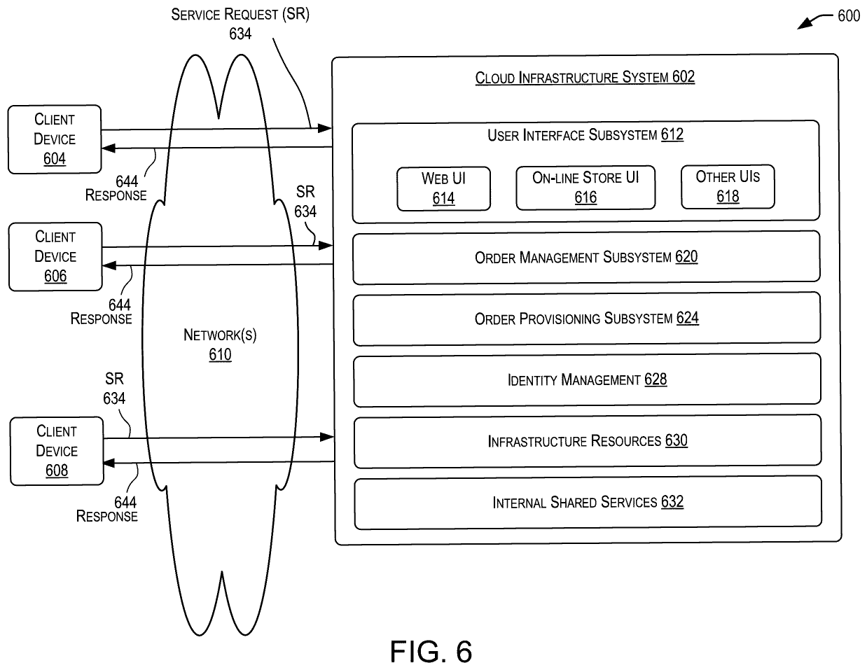

FIG. 6 is a simplified block diagram of a cloud-based system environment in which task completion narratives are managed and generated, in accordance with certain aspects. In the embodiment depicted in FIG. 6, cloud infrastructure system 602 may provide one or more cloud services that may be requested by users using one or more client computing devices 604, 606, and 608. Cloud infrastructure system 602 may comprise one or more computers and/or servers that may include those described above for server 512. The computers in cloud infrastructure system 602 may be organized as general purpose computers, specialized server computers, server farms, server clusters, or any other appropriate arrangement and/or combination.

Network(s) 610 may facilitate communication and exchange of data between clients 604, 606, and 608 and cloud infrastructure system 602. Network(s) 610 may include one or more networks. The networks may be of the same or different types. Network(s) 610 may support one or more communication protocols, including wired and/or wireless protocols, for facilitating the communications.

The embodiment depicted in FIG. 6 is only one example of a cloud infrastructure system and is not intended to be limiting. It should be appreciated that, in some other aspects, cloud infrastructure system 602 may have more or fewer components than those depicted in FIG. 6, may combine two or more components, or may have a different configuration or arrangement of components. For example, although FIG. 6 depicts three client computing devices, any number of client computing devices may be supported in alternative aspects.

The term cloud service is generally used to refer to a service that is made available to users on demand and via a communication network such as the Internet by systems (e.g., cloud infrastructure system 602) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 610 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 602 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 602 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 602. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 602. Cloud infrastructure system 602 then performs processing to provide the services requested in the tenant's subscription order. Cloud infrastructure system 602 may be configured to provide one or even multiple cloud services.

Cloud infrastructure system 602 may provide the cloud services via different deployment models. In a public cloud model, cloud infrastructure system 602 may be owned by a third party cloud services provider and the cloud services are offered to any general public tenant, where the tenant can be an individual or an enterprise. In certain other aspects, under a private cloud model, cloud infrastructure system 602 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 602 and the services provided may be shared by several organizations in a related community. Various other models such as hybrids of the above-mentioned models may also be used.

Client computing devices 604, 606, and 608 may be of different types (such as devices 502, 504, 506, and 508 depicted in FIG. 5) and may be capable of operating one or more client applications. A user may use a client device to interact with cloud infrastructure system 602, such as to request a service provided by cloud infrastructure system 602.

In some aspects, the processing performed by cloud infrastructure system 602 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 602 for determining the intent of an utterance. The data used for this analysis may include structured data (e.g., data stored in a database or structured according to a structured model) and/or unstructured data (e.g., data blobs (binary large objects)).

As depicted in the embodiment in FIG. 6, cloud infrastructure system 602 may include infrastructure resources 630 that are utilized for facilitating the provision of various cloud services offered by cloud infrastructure system 602. Infrastructure resources 630 may include, for example, processing resources, storage or memory resources, networking resources, and the like.

In certain aspects, to facilitate efficient provisioning of these resources for supporting the various cloud services provided by cloud infrastructure system 602 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 602 may itself internally use services 632 that are shared by different components of cloud infrastructure system 602 and which facilitate the provisioning of services by cloud infrastructure system 602. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 602 may comprise multiple subsystems. These subsystems may be implemented in software, or hardware, or combinations thereof. As depicted in FIG. 6, the subsystems may include a user interface subsystem 612 that enables users of cloud infrastructure system 602 to interact with cloud infrastructure system 602. User interface subsystem 612 may include various different interfaces such as a web interface 614, an online store interface 616 where cloud services provided by cloud infrastructure system 602 are advertised and are purchasable by a consumer, and other interfaces 618. For example, a tenant may, using a client device, request (service request 634) one or more services provided by cloud infrastructure system 602 using one or more of interfaces 614, 616, and 618. For example, a tenant may access the online store, browse cloud services offered by cloud infrastructure system 602, and place a subscription order for one or more services offered by cloud infrastructure system 602 that the tenant wishes to subscribe to. The service request may include information identifying the tenant and one or more services that the tenant desires to subscribe to.

In certain aspects, such as the embodiment depicted in FIG. 6, cloud infrastructure system 602 may comprise an order management subsystem (OMS) 620 that is configured to process the new order. As part of this processing, OMS 620 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 620 may then invoke the order provisioning subsystem (OPS) 624 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 624 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 602 may send a response or notification 644 to the requesting tenant to indicate when the requested service is now ready for use. In some instances, information (e.g., a link) may be sent to the tenant that enables the tenant to start using and availing the benefits of the requested services.

Cloud infrastructure system 602 may provide services to multiple tenants. For each tenant, cloud infrastructure system 602 is responsible for managing information related to one or more subscription orders received from the tenant, maintaining tenant data related to the orders, and providing the requested services to the tenant or clients of the tenant. Cloud infrastructure system 602 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 602 may provide services to multiple tenants in parallel. Cloud infrastructure system 602 may store information for these tenants, including possibly proprietary information. In certain aspects, cloud infrastructure system 602 comprises an identity management subsystem (IMS) 628 that is configured to manage tenant's information and provide the separation of the managed information such that information related to one tenant is not accessible by another tenant. IMS 628 may be configured to provide various security-related services such as identity services, such as information access management, authentication and authorization services, services for managing tenant identities and roles and related capabilities, and the like.

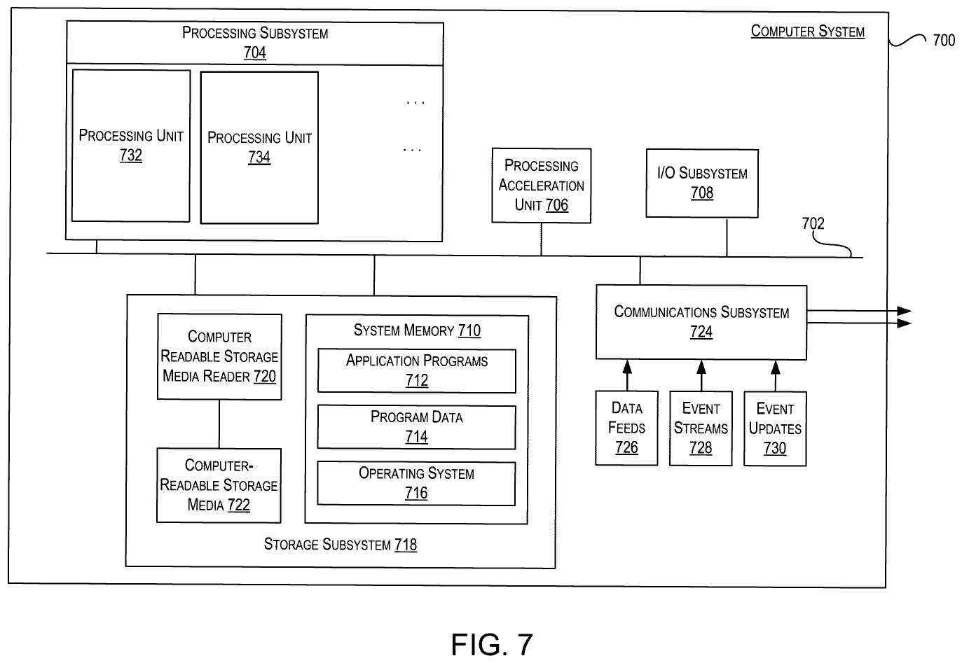

FIG. 7 illustrates an exemplary computer system 700 that may be used to implement certain aspects. As shown in FIG. 7, computer system 700 includes various subsystems including a processing subsystem 704 that communicates with a number of other subsystems via a bus subsystem 702. These other subsystems may include a processing acceleration unit 706, an I/O subsystem 708, a storage subsystem 718, and a communications subsystem 724. Storage subsystem 718 may include non-transitory computer-readable storage media including storage media 722 and a system memory 710.

Bus subsystem 702 provides a mechanism for letting the various components and subsystems of computer system 700 communicate with each other as intended. Although bus subsystem 702 is shown schematically as a single bus, alternative aspects of the bus subsystem may utilize multiple buses. Bus subsystem 702 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 704 controls the operation of computer system 700 and may comprise one or more processors, application specific integrated circuits (ASICs), or field programmable gate arrays (FPGAs). The processors may be single core or multicore processors. The processing resources of computer system 700 can be organized into one or more processing units 732, 734, etc. A processing unit may include one or more processors, one or more cores from the same or different processors, a combination of cores and processors, or other combinations of cores and processors. In some aspects, processing subsystem 704 can include one or more special purpose co-processors such as graphics processors, digital signal processors (DSPs), or the like. In some aspects, some or all of the processing units of processing subsystem 704 can be implemented using customized circuits, such as application specific integrated circuits (ASICs), or field programmable gate arrays (FPGAs).

In some aspects, the processing units in processing subsystem 704 can execute instructions stored in system memory 710 or on computer readable storage media 722. In various aspects, the processing units can execute a variety of programs or code instructions and can maintain multiple concurrently executing programs or processes. At any given time, some or all of the program code to be executed can be resident in system memory 710 and/or on computer-readable storage media 722 including potentially on one or more storage devices. Through suitable programming, processing subsystem 704 can provide various functionalities described above. In instances where computer system 700 is executing one or more virtual machines, one or more processing units may be allocated to each virtual machine.

In certain aspects, a processing acceleration unit 706 may optionally be provided for performing customized processing or for off-loading some of the processing performed by processing subsystem 704 so as to accelerate the overall processing performed by computer system 700.

I/O subsystem 708 may include devices and mechanisms for inputting information to computer system 700 and/or for outputting information from or via computer system 700. In general, use of the term input device is intended to include all possible types of devices and mechanisms for inputting information to computer system 700. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 700 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 718 provides a repository or data store for storing information and data that is used by computer system 700. Storage subsystem 718 provides a tangible non-transitory computer-readable storage medium for storing the basic programming and data constructs that provide the functionality of some aspects. Storage subsystem 718 may store software (e.g., programs, code modules, instructions) that when executed by processing subsystem 704 provides the functionality described above. The software may be executed by one or more processing units of processing subsystem 704. Storage subsystem 718 may also provide a repository for storing data used in accordance with the teachings of this disclosure.

Storage subsystem 718 may include one or more non-transitory memory devices, including volatile and non-volatile memory devices. As shown in FIG. 7, storage subsystem 718 includes a system memory 710 and a computer-readable storage media 722. System memory 710 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 700, such as during start-up, may typically be stored in the ROM. The RAM typically contains data and/or program modules that are presently being operated and executed by processing subsystem 704. In some implementations, system memory 710 may include multiple different types of memory, such as static random access memory (SRAM), dynamic random access memory (DRAM), and the like.

By way of example, and not limitation, as depicted in FIG. 7, system memory 710 may load application programs 712 that are being executed, which may include various applications such as Web browsers, mid-tier applications, relational database management systems (RDBMS), etc., program data 714, and an operating system 716. By way of example, operating system 716 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 722 may store programming and data constructs that provide the functionality of some aspects. Computer-readable media 722 may provide storage of computer-readable instructions, data structures, program modules, and other data for computer system 700. Software (programs, code modules, instructions) that, when executed by processing subsystem 704 provides the functionality described above, may be stored in storage subsystem 718. By way of example, computer-readable storage media 722 may include non-volatile memory such as a hard disk drive, a magnetic disk drive, an optical disk drive such as a CD ROM, digital video disc (DVD), a Blu-Ray® disk, or other optical media. Computer-readable storage media 722 may include, but is not limited to, Zip® drives, flash memory cards, universal serial bus (USB) flash drives, secure digital (SD) cards, DVD disks, digital video tape, and the like. Computer-readable storage media 722 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 718 may also include a computer-readable storage media reader 720 that can further be connected to computer-readable storage media 722. Reader 720 may receive and be configured to read data from a memory device such as a disk, a flash drive, etc.

In certain aspects, computer system 700 may support virtualization technologies, including but not limited to virtualization of processing and memory resources. For example, computer system 700 may provide support for executing one or more virtual machines. In certain aspects, computer system 700 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 700. Accordingly, multiple operating systems may potentially be run concurrently by computer system 700.

Communications subsystem 724 provides an interface to other computer systems and networks. Communications subsystem 724 serves as an interface for receiving data from and transmitting data to other systems from computer system 700. For example, communications subsystem 724 may enable computer system 700 to establish a communication channel to one or more client devices via the Internet for receiving and sending information from and to the client devices.

Communication subsystem 724 may support both wired and/or wireless communication protocols. For example, in certain aspects, communications subsystem 724 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 724 can provide wired network connectivity (e.g., Ethernet) in addition to or instead of a wireless interface.

Communication subsystem 724 can receive and transmit data in various forms. For example, in some aspects, in addition to other forms, communications subsystem 724 may receive input communications in the form of structured and/or unstructured data feeds 726, event streams 728, event updates 730, and the like. For example, communications subsystem 724 may be configured to receive (or send) data feeds 726 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 724 may be configured to receive data in the form of continuous data streams, which may include event streams 728 of real-time events and/or event updates 730, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 724 may also be configured to communicate data from computer system 700 to other computer systems or networks. The data may be communicated in various different forms such as structured and/or unstructured data feeds 726, event streams 728, event updates 730, and the like to one or more databases that may be in communication with one or more streaming data source computers coupled to computer system 700.

Computer system 700 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 700 depicted in FIG. 7 is intended only as a specific example. Many other configurations having more or fewer components than the system depicted in FIG. 7 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
storing a plurality of task records, wherein each task record comprises characteristics of a task of a plurality of tasks and a task status; wherein a particular task record for a particular task comprises a particular task status value for the task status that indicates the particular task is not completed; wherein the particular task record identifies, in association with the task, a team of one or more actors of a plurality of actors and a candidate partner of a plurality of candidate partners;
storing an action trigger in association with the plurality of task records, wherein the action trigger comprises:
one or more conditions that are based at least in part on the task status, and
a referenced API that uses a specified path to call a large language model;
storing a user-modifiable template for prompts to the large language model, the user-modifiable template comprising a plurality of placeholders for a plurality of characteristics including one or more particular characteristics, the user-modifiable template further comprising modifiable static text to appear in the prompts;
for the particular task record, receiving an update to the particular task status value indicating the particular task is completed, wherein the one or more particular characteristics of the particular task record comprise one or more particular values that are unique to the particular task among the plurality of tasks;
based at least in part on the update, detecting that the one or more conditions are satisfied for the particular task record;
in response to detecting that the one or more conditions are satisfied for the particular task record, generating a task completion narrative at least in part by:
identifying the particular task record for the task completion narrative;
populating the user-modifiable template to generate a particular prompt at least in part by substituting the one or more particular values of the one or more particular characteristics for one or more placeholders of the plurality of placeholders;
triggering a call to the large language model using the specified path; wherein the call includes the particular prompt to the large language model comprising the one or more particular values of the one or more particular characteristics of the particular task record and the modifiable static text;
receiving and storing the task completion narrative in a task completion narrative field of the particular task record;
accessing the task completion narrative field to cause display of the task completion narrative to at least one actor of the plurality of actors.

2. The computer-implemented method of claim 1, wherein the one or more particular characteristics of the particular task record comprise one or more other particular values that are shared by one or more other tasks of the plurality of tasks, the computer-implemented method further comprising receiving, via a user interface, a request for information relating to tasks having the one or more other particular values; wherein accessing the task completion narrative field to cause display of the task completion narrative is performed in response to the request.

3. The computer-implemented method of claim 1, wherein the one or more particular values describe one or more interactions between the team and the candidate partner in natural language text, wherein the modifiable static text comprises one or more section headers of one or more blank sections to be completed by the large language model, the computer-implemented method further comprising:
generating, by the large language model, one or more summaries of the one or more interactions to address the one or more section headers, and including the one or more summaries in the task completion narrative to fill in the one or more blank sections.

4. The computer-implemented method of claim 1, further comprising:
accessing one or more values of one or more characteristics of the plurality of characteristics;
determining that the one or more values of the one or more characteristics of the plurality of characteristics satisfy one or more data exclusion conditions;
based at least in part on determining that the one or more values of the one or more characteristics satisfy the one or more data exclusion conditions, excluding the one or more values from the particular prompt even though the user-modifiable template comprises one or more placeholders for the one or more characteristics.

5. The computer-implemented method of claim 1, wherein generating the task completion narrative further comprises:
receiving an initial task completion narrative from the large language model;
determining whether the initial task completion narrative comprises any data characteristics that satisfy one or more data exclusion conditions;
based at least in part on determining the initial task completion narrative comprises one or more data characteristics that satisfy the one or more data exclusion conditions, prompting the large language model to provide another task completion narrative that removes the one or more data characteristics from the initial task completion narrative.

6. The computer-implemented method of claim 1, further comprising storing one or more validation rules in association with the task completion narrative field; wherein the one or more validation rules comprise one or more constraints on content that can be stored in the task completion narrative field, and wherein storing the task completion narrative in the task completion narrative field is performed based at least in part on determining that the one or more constraints are satisfied.

7. The computer-implemented method of claim 1, wherein accessing the task completion narrative field to cause display of the task completion narrative to at least one actor comprises triggering an email communication to at least one other team of a plurality of teams, wherein the particular task record is not modifiable by at least one actor of the plurality of actors on the at least one other team.

8. The computer-implemented method of claim 1, wherein accessing the task completion narrative field to cause display of the task completion narrative to at least one actor comprises triggering an email communication to at least one actor on the team, wherein the email communication comprises an interactive option which, when selected, triggers one or more email communications to at least one other team of a plurality of teams, wherein the particular task record is modifiable by the at least one actor on the team but is not modifiable by at least one other actor of the plurality of actors on the at least one other team.

9. The computer-implemented method of claim 1, wherein the particular prompt includes an example of another task completion narrative that is based on other information that does not have the one or more particular values for the one or more particular characteristics but has one or more other values for the one or more particular characteristics.

10. The computer-implemented method of claim 1, wherein the one or more particular characteristics of the particular task record comprise one or more other particular values that are shared by one or more other tasks of the plurality of tasks, the computer-implemented method further comprising summarizing a plurality of task completion narrative fields for a plurality of tasks sharing a particular value of the one or more other particular values at least in part by prompting the large language model with the plurality of task completion narrative fields and other modifiable static text.

11. The computer-implemented method of claim 1, further comprising:
detecting that at least one of the plurality of characteristics is in a different language than a target language of the particular prompt; and
transforming the at least one of the plurality of characteristics to the target language before including the at least one of the plurality of characteristics in the particular prompt.

12. The computer-implemented method of claim 1, further comprising:
detecting that at least one of the plurality of characteristics may be in a different language than a target language of the particular prompt; and
adding, to the particular prompt, text requesting that the task completion narrative be provided in the target language.

13. The computer-implemented method of claim 1, wherein accessing the task completion narrative field to cause display of the task completion narrative to at least one actor comprises conditionally rendering the task completion narrative field in a user interface for viewing details about the particular task based at least in part on determining that the task completion narrative field is not blank.

14. The computer-implemented method of claim 1, further comprising causing display of the user-modifiable template at least in part by displaying the plurality of placeholders as movable graphical objects within the modifiable static text.

15. A computer-program product comprising one or more non-transitory machine-readable storage media, including stored instructions configured to cause a computing system to perform a set of actions including:
storing a plurality of task records, wherein each task record comprises characteristics of a task of a plurality of tasks and a task status; wherein a particular task record for a particular task comprises a particular task status value for the task status that indicates the particular task is not completed; wherein the particular task record identifies, in association with the task, a team of one or more actors of a plurality of actors and a candidate partner of a plurality of candidate partners;
storing an action trigger in association with the plurality of task records, wherein the action trigger comprises:
one or more conditions that are based at least in part on the task status, and
a referenced API that uses a specified path to call a large language model;
storing a user-modifiable template for prompts to the large language model, the user-modifiable template comprising a plurality of placeholders for a plurality of characteristics including one or more particular characteristics, the user-modifiable template further comprising modifiable static text to appear in the prompts;
for the particular task record, receiving an update to the particular task status value indicating the particular task is completed, wherein the one or more particular characteristics of the particular task record comprise one or more particular values that are unique to the particular task among the plurality of tasks;
based at least in part on the update, detecting that the one or more conditions are satisfied for the particular task record;
in response to detecting that the one or more conditions are satisfied for the particular task record, generating a task completion narrative at least in part by:
identifying the particular task record for the task completion narrative;
populating the user-modifiable template to generate a particular prompt at least in part by substituting the one or more particular values of the one or more particular characteristics for one or more placeholders of the plurality of placeholders;
triggering a call to the large language model using the specified path; wherein the call includes the particular prompt to the large language model comprising the one or more particular values of the one or more particular characteristics of the particular task record and the modifiable static text;
receiving and storing the task completion narrative in a task completion narrative field of the particular task record;
accessing the task completion narrative field to cause display of the task completion narrative to at least one actor of the plurality of actors.

16. The computer-program product of claim 15, wherein accessing the task completion narrative field to cause display of the task completion narrative to at least one actor comprises triggering an email communication to at least one actor on the team, wherein the email communication comprises an interactive option which, when selected, triggers one or more email communications to at least one other team of a plurality of teams, wherein the particular task record is modifiable by the at least one actor on the team but is not modifiable by at least one other actor of the plurality of actors on the at least one other team.

17. The computer-program product of claim 15, wherein the one or more particular characteristics of the particular task record comprise one or more other particular values that are shared by one or more other tasks of the plurality of tasks, wherein the set of actions further include summarizing a plurality of task completion narrative fields for a plurality of tasks sharing a particular value of the one or more other particular values at least in part by prompting the large language model with the plurality of task completion narrative fields and other modifiable static text.

18. The computer-program product of claim 15, wherein the set of actions further include causing display of the user-modifiable template at least in part by displaying the plurality of placeholders as movable graphical objects within the modifiable static text.

19. A system comprising:
one or more processors;
one or more non-transitory computer-readable media storing instructions, which, when executed by the system, cause the system to perform a set of actions including:
storing a plurality of task records, wherein each task record comprises characteristics of a task of a plurality of tasks and a task status; wherein a particular task record for a particular task comprises a particular task status value for the task status that indicates the particular task is not completed; wherein the particular task record identifies, in association with the task, a team of one or more actors of a plurality of actors and a candidate partner of a plurality of candidate partners;
storing an action trigger in association with the plurality of task records, wherein the action trigger comprises:
one or more conditions that are based at least in part on the task status, and
a referenced API that uses a specified path to call a large language model;
storing a user-modifiable template for prompts to the large language model, the user-modifiable template comprising a plurality of placeholders for a plurality of characteristics including one or more particular characteristics, the user-modifiable template further comprising modifiable static text to appear in the prompts;
for the particular task record, receiving an update to the particular task status value indicating the particular task is completed, wherein the one or more particular characteristics of the particular task record comprise one or more particular values that are unique to the particular task among the plurality of tasks;
based at least in part on the update, detecting that the one or more conditions are satisfied for the particular task record;
in response to detecting that the one or more conditions are satisfied for the particular task record, generating a task completion narrative at least in part by:
identifying the particular task record for the task completion narrative;
populating the user-modifiable template to generate a particular prompt at least in part by substituting the one or more particular values of the one or more particular characteristics for one or more placeholders of the plurality of placeholders;
triggering a call to the large language model using the specified path; wherein the call includes the particular prompt to the large language model comprising the one or more particular values of the one or more particular characteristics of the particular task record and the modifiable static text;
receiving and storing the task completion narrative in a task completion narrative field of the particular task record;
accessing the task completion narrative field to cause display of the task completion narrative to at least one actor of the plurality of actors.

20. The system of claim 19, wherein accessing the task completion narrative field to cause display of the task completion narrative to at least one actor comprises triggering an email communication to at least one actor on the team, wherein the email communication comprises an interactive option which, when selected, triggers one or more email communications to at least one other team of a plurality of teams, wherein the particular task record is modifiable by the at least one actor on the team but is not modifiable by at least one other actor of the plurality of actors on the at least one other team.

21. The system of claim 19, wherein the one or more particular characteristics of the particular task record comprise one or more other particular values that are shared by one or more other tasks of the plurality of tasks, wherein the set of actions further include summarizing a plurality of task completion narrative fields for a plurality of tasks sharing a particular value of the one or more other particular values at least in part by prompting the large language model with the plurality of task completion narrative fields and other modifiable static text.
